(19) United States
(12) Patent Application Publication
(10) Pub. No.: US 2007/0179897 A1
(43) Pub. Date: Aug. 2, 2007

(54) Conditional stream access

(76) Inventor: Stefan Andersson, Klagerup (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/340,890

(22) Filed: Jan. 27, 2006

(51) Int. Cl. G06Q 99/00

(52) U.S. Cl. 705/59

(57) ABSTRACT

A method of transacting business in conjunction with playing protected media content owned by a media content owner, wherein said protected media content has been provided and enabled for playback on a first electronic equipment. The protected media content is streamed from the first electronic equipment to a second electronic equipment, wherein said streamed media content is in a disabled state on the second electronic equipment, and a license is obtained from an authorization server, said license enabling playback of the protected media content on the second electronic equipment. The authorization server provides a credit to the media content provider based on the enablement of the protected media content on the second electronic equipment.

### TECHNICAL FIELD OF THE INVENTION

The present invention relates generally to the field of media content distribution and, more particularly, to a system and method for creating a revenue stream for media content providers when the content is streamed peer-to-peer.

### DESCRIPTION OF RELATED ART

For many years, people have been entertained by media content, such as radio and television programs, that is broadcast over the air and received in homes, offices and/or automobiles. Such media content typically is formed of video and/or audio content. FIG. 1 is an exemplary block diagram 10 that illustrates the cycle of such media content from its initial “creation” stages to its final reception by a target audience.

Initially, a content creator 12 creates the media content, which may comprise sound (including verbal sounds, non-verbal sounds, and music) and/or video. Such content typically is professionally produced in a studio (e.g., a sound studio and/or movie studio), for example. Once the media content is created, the media content is provided to a distribution network 14, which makes the media content available to a large group of people. Generally, such distribution networks 14 comprise a radio station or a television station, for example. More recently, such distribution networks 14 have grown to include computer servers coupled to the internet.

The distribution network 14 then distributes or otherwise makes the media content available to a large audience via a distribution medium 16. The distribution medium 16 may be via radio waves (e.g., radio, television, satellite transmission/reception) and can be in analog or digital form. With respect to computer servers, the distribution medium may be the internet, for example. Generally, media content distribution is performed via a broadcast, wherein the media content is made available to all at substantially the same time. Individuals may receive the broadcast by “tuning” into the broadcast (e.g., selecting a frequency that carries the broadcast). Upon broadcast of the media content, any number of individuals 18a-18n may receive the broadcast substantially simultaneously via a content playback device 20a-20n, such as a radio, television, a computer, etc.

A drawback to such broadcast distribution methods is that the media content is available only at a time set by the distribution network 14. Thus, some individuals may not be able to listen to or watch the media content simply due to scheduling conflicts or being out of the broadcast range of the transmission (e.g., traveling at the time of broadcast). To remedy this problem, recorders 22a-22n were developed that enabled the media content to be recorded as it was broadcast, and replayed at a time that was more convenient for the particular individual.

In the early days of media content distribution, one generally could enjoy the media content free of charge, provided they had the necessary equipment (e.g., a radio or television). Recently (i.e., within about the last fifty years), so called premium services have emerged that charge a fee for the right to receive and playback premium media content. These premium services typically offer a greater variety of media content, some of which is commercial free, and can include so called “video on demand” services (e.g., the video is provided at a time requested by the recipient). Such premium services include subscriptions to cable television, satellite television, and satellite radio, for example. In order to playback or view such premium media content, special equipment is required (e.g., a cable hook-up, a satellite hook-up, a receiver and/or smart card 24a-24n). As is known in the art, a smart card is an electronic device that identifies the subscriber and can decode the premium signals, thereby enabling the media content.

Such premium content systems are said to be conditional access systems. That is, only authorized individuals (e.g., those who have paid for the service) may view the premium content. Additionally, while the individuals 18a-18n can receive the media content (premium and non-premium), their ability to rebroadcast such content is limited and generally discouraged.

The recent growth of the internet and digital technology has resulted in numerous new conduits for distributing media content, including, for example, peer-to-peer technologies. Peer-to-peer refers generally to software that enables an electronic device, such as a computer, to locate and/or transfer a content file from one networked device to another. Peer-to-peer connections allow individuals to transfer or stream media content from one location to another (e.g., from one computer to another via BlueTooth, WLAN, or the like).

### SUMMARY OF THE INVENTION

Peer-to-peer transmission of media content has become one of the main methods in which data is shared over the internet. With the advent of “podcasting” and other peer-to-peer technologies, there are situations where content is transferred or streamed such that it can become a virtual broadcast. Such peer-to-peer transmissions of media content present a problem for media content owners and/or providers. For example, all current DRM (digital rights management) schemes are designed to prevent flow of data unless the content file itself is purchased and downloaded. Presently, there are no solutions to create a revenue stream for content providers when the content is being streamed peer-to-peer. Thus, each time media content is streamed peer-to-peer, the media content owner/provider effectively is loosing revenue.

The present invention provides a system and method for creating a conditional stream access system. In such a system, content providers may gain revenue when the content is streamed peer-to-peer, including peer-to-peer broadcasts (e.g., streaming media content to a group of friends or peer-to-multipeer).

According to one aspect of the invention, there is provided a method of transacting business in conjunction with playing protected media content owned by a media content owner, wherein said protected media content has been provided and enabled for playback on a first electronic equipment. The protected media content can be streamed from the first electronic equipment to a second electronic equipment, wherein said streamed media content can be in a disabled state on the second electronic equipment. A license that enables playback of the protected media content on the second electronic equipment can be obtained from an authorization server.

In one embodiment, a mobile phone can be used as the electronic equipment. In another embodiment, streaming the protected media content can include at least one of streaming peer-to-peer or streaming peer-to-multipeer. In yet another embodiment, the media content can be streamed via a first medium and the license can be provided via a second medium different from the first medium. In another embodiment, a medium used for streaming the media content and a medium used for providing the key can be the same medium.

In yet another embodiment, playback can include playing the media content on the electronic equipment. In another embodiment, the license can include a key that enables the media content. In yet another embodiment, the key obtained by the second electronic equipment can be different from the key obtained by the first electronic equipment.

In another embodiment, credits can be provided to an owner of the respective electronic equipment each time the respective electronic equipment streams the media content to a different electronic equipment of the plurality of electronic equipment and the media content is enabled on the different electronic equipment.

In yet another embodiment, each stream of the media content can include encoding the media content with an identifier prior to transmission, said identifier indicative of a generation of the media content relative to a previous transmission of the media content.

In another embodiment, a license for the media content can be denied if the identifier corresponds to a predetermined identifier or range of identifiers. In another embodiment, obtaining the license can include obtaining the license without user intervention. In yet another embodiment, obtaining the license can include obtaining the license based on a subscription service or a pay-per-use service. In another embodiment, obtaining the license can include obtaining the license as the media is streamed or after the media has been streamed.

In yet another embodiment, a credit can be provided to the media content provider based on the enablement of the protected media content.

According to another aspect of the invention, there is provided a program embodied in a computer readable medium for playing protected media content on at least one of a plurality of mobile radio terminals. The program can include code that streams the protected media content from a first mobile radio terminal of the plurality of mobile radio terminals to a second mobile radio terminal of the plurality of mobile radio terminals, wherein said streamed media content is in a disabled state on the second mobile radio terminal, and code that obtains from an authorization server a license that enables playback of the protected media content on the second mobile radio terminal.

According to another aspect of the invention, there is provided a system for providing conditional access of media content distributed between a plurality of electronic equipment. The system can include a distribution server that includes media content stored thereon, an authentication server for selectively providing a license to enable the media content, and first and second electronic equipment of the plurality of electronic equipment. The first electronic equipment can include disabled media content obtained from the distribution server, and a license obtained from the authentication server, said license enabling the media content. The media content can be streamed from the first electronic equipment to the second electronic equipment, said media content being in a disabled state on the second electronic equipment, and said second electronic equipment obtaining a license for the media content to enable the media content.

In one embodiment, the second electronic equipment can obtain the license directly from the authentication server. In another embodiment, the second electronic equipment can obtain the license from the authentication server through the first electronic equipment. In yet another embodiment, a content owner of the media content can receive a credit each time a license is obtained for the media content. In yet another embodiment, an owner of each electronic equipment of the plurality of electronic equipment can receive a credit each time a license is obtained for media content transmitted by the respective electronic equipment.

In another embodiment, the authentication server and the distribution server can be the same server. In yet another embodiment, the media content can be at least one of an audio file, video file, or executable code. In another embodiment, the electronic equipment can be a mobile phone.

In yet another embodiment, streaming the media content can include at least one of streaming peer-to-peer or streaming peer-to-multipeer. In another embodiment, media content can be executable or playable on the electronic equipment. In another embodiment, the license can include a key that enables the media content.

In yet another embodiment, each stream of the media content can include encoding the media content with an identifier prior to transmission, said identifier indicative of a generation of the media content relative to a previous transmission of the media content. In another embodiment, the authentication server can deny a license for the media content if the identifier corresponds to a predetermined identifier or range of identifiers.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a block diagram illustrating an exemplary method of providing media content to an audience.

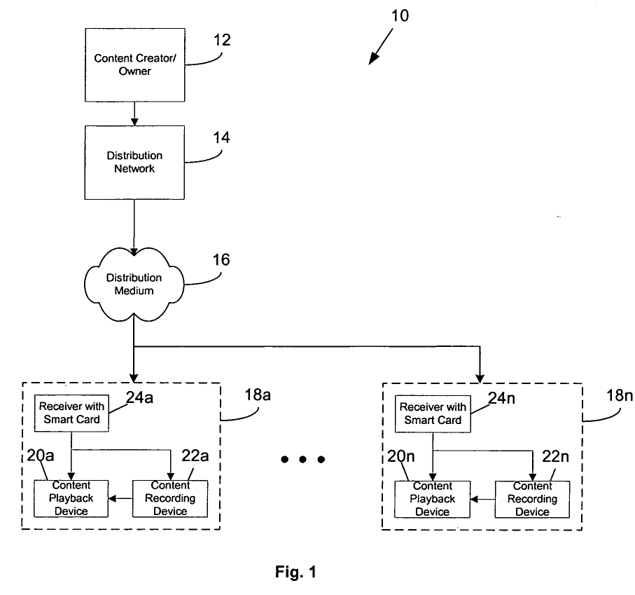

FIG. 2 is a block diagram of an exemplary method of providing conditional stream access of media content in accordance with the invention.

FIG. 3 is a schematic diagram illustrating exemplary methods in which media content may be exchanged between electronic equipment in accordance with the invention.

FIG. 4 is a block diagram illustrating an exemplary data format in accordance with the invention.

FIG. 5 is an exemplary block diagram of a mobile phone that can be used in conjunction with the invention.

FIGS. 6A and 6B are flow diagrams illustrating an exemplary method of implementing conditional stream access in accordance with the invention.

### DETAILED DESCRIPTION OF EMBODIMENTS

The term electronic equipment includes portable radio communication equipment. The term portable radio communication equipment, which hereinafter is referred to as a mobile radio terminal, includes equipment such as mobile telephones, communicators, e.g., electronic organizers, personal digital assistants (PDAs) smart phones or the like.

The term media content includes any content that comprises at least one of sound, video, information (textual and/or graphical), executable code, or the like. The term streaming includes the transfer of data at a rate of speed sufficient to support a specified bandwidth and/or the transfer of data at a speed sufficient to support direct rendering. The terms disabled and enabled, when used with respect to the term media content, refer to a methodology that determines if the media content can be executed and/or reproduced. Such methodology includes one or more of encryption/decryption techniques, digital rights management techniques, or the like, that allow media content to be locked and unlocked. If the media content is disabled, it is said to be locked or deactivated and cannot be executed, played and/or reproduced without first obtaining authorization. If the media content is enabled, it is said to be unlocked or activated and it may be executed, played and/or reproduced.

A conditional-access system is a simple form of rights-management system in which subscribers are given access to objects based (typically) on a service contract. The present invention provides conditional stream access of media content, wherein protected media content can be transferred or streamed from a first source to a second source. More specifically, the media content creator/owner (hereinafter referred to as media content owner) can obtain credit (e.g., payment) each time the media content is streamed from one source to another, even when the originating source is not the media content provider or anyone affiliated with the media content provider. In other words, the media content source may be any individual who has a copy of the media content, whether an original copy or a copy that has been exchanged between any number of individuals.

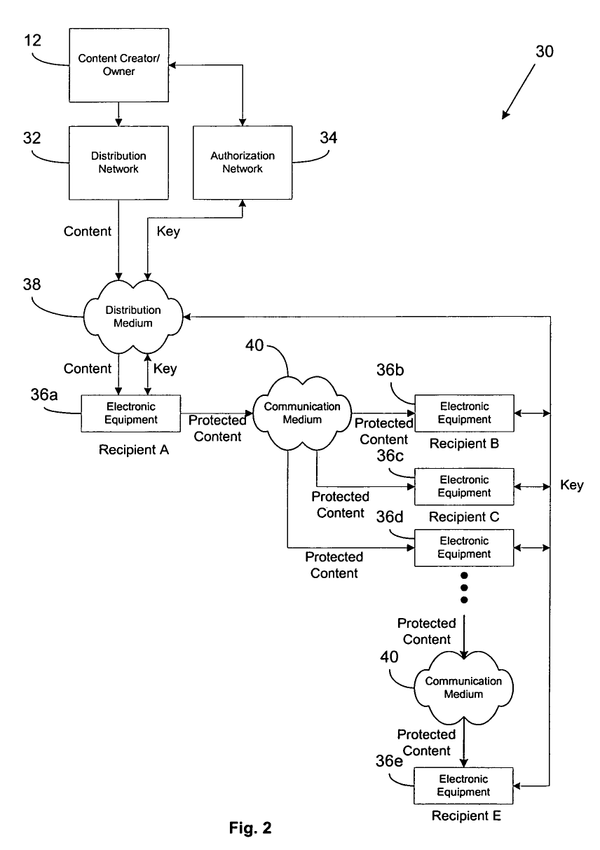

Referring to FIG. 2, there is provided a block diagram 30 of an exemplary system for providing conditional stream access. A content owner 12, such as a musician, a movie studio, a game studio, a software developer, or the like, creates a media content for distribution. The content may be created as a digital file, including but not limited to a compressed or non-compressed music file (e.g., an mp3 file or a windows media file), video file (e.g., an mpeg file or an avi file), or executable code (e.g., software executable by a processor). Further, the content owner intends to receive a fee for each copy of the media content that is distributed. This distribution includes both distribution from a main source (e.g., a dedicated server affiliated with the content owner) and distribution via users who previously obtained the media content and wish to forward it to a friend or group of friends (e.g., transferring or streaming the media content from one user to one or more recipients, without the recipients accessing the main distribution server).

Upon creation of the media content, the content owner provides the media content, which is in a disabled form, to a distribution network 32. The distribution network 32 can be a server 32 (e.g., a web server or a streaming server) or the like that is accessible by a number of individuals (e.g., via a wired or wireless network connection including the internet, a cable subscription service, a satellite subscription service, etc.), or any other means in which media content may be communicated from one device to another.

Additionally, the content owner sets up an account on an authorization network 34, which may be a server 34 (e.g., a license issuing server) accessible in a manner similar to the server of the distribution network 32. As discussed in more detail below, the authorization network 34 provides a means for enabling the disabled media content once the media content is paid for by a purchaser, and a means for the content owner to receive credit (e.g., payment) from the purchaser. Further, while the authorization network 34 is illustrated as being separate from the distribution network 32, it will be appreciated that both the distribution network 32 and the authorization network 34 may be embodied in a common device (e.g., on the same server). Once the content is made available via the distribution network 32 and the content owner's account has been created via the authorization network 34, the media content is available for others to transfer (e.g., download) and purchase, wherein the content owner can receive credit for each purchase, as discussed in more detail below.

A potential purchaser, via a first electronic equipment 36a coupled to the distribution medium 38, may browse the media content made available by the distribution network 32. The distribution medium 38 can be the internet, a cable or satellite subscription service, a telephone connection, or any other medium that can be used to view and/or exchange data.

For example, the potential purchaser may access an interface, such as a web page or the like, to view the media content available on the distribution network 32. The interface can include basic search and sorting functions, as is conventional. Upon finding a media content that the potential purchaser wishes to obtain, he may click on the media content, at which point a file transfer or file stream is initiated from the distribution network 32 to the first electronic equipment 36a via the distribution medium 38.

While the media content is being transferred or streamed to the first electronic equipment 36a, it is in a disabled state. That is, the media content, while present on the first electronic equipment 36a, cannot be played, executed and/or reproduced. To view, listen to, or execute the media content, the potential purchaser must access the authorization network 34 and pay for the right to play the media content. Payment can be in any one of a number of different conventional methods. For example, the potential purchaser may pay for each media content as it is downloaded (e.g., a pay-per-view or pay-per-use service), or he may have a subscription that allows unlimited or a predetermined number of downloads/transfers (e.g., a subscription service).

Once the media content is purchased (whether by a pay-per-view service or a subscription service), the media content is enabled or activated, such that it is playable on the first electronic equipment 36a. Enablement of the media content can be via any one of a number of conventional techniques. In one embodiment, a key is provided to the first electronic equipment 36a that enables the media content. The key may be provided using the same distribution medium used for providing the media content, or via a distribution medium different from that used to provide the media content. For example, the media content may be provided via an internet connection, while the key may be provided via a cellular telephone connection.

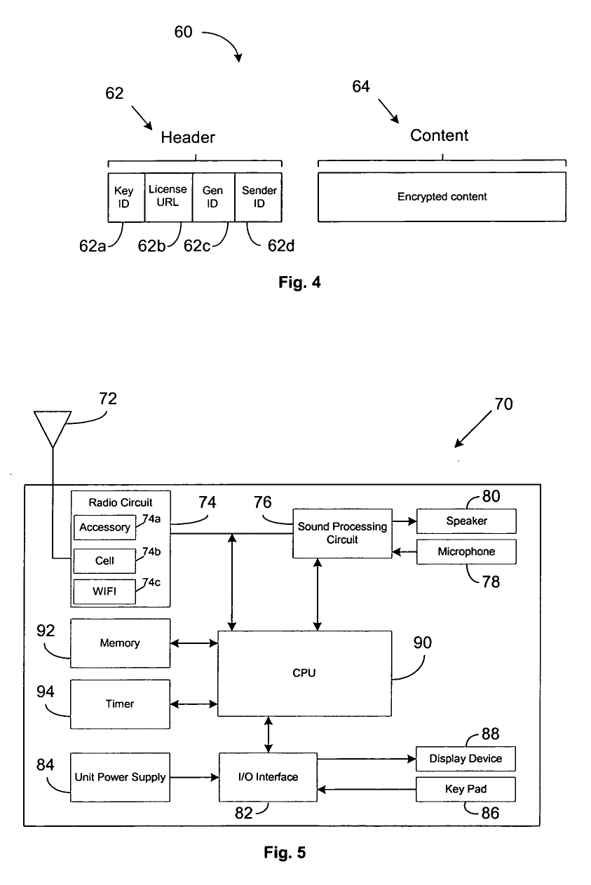

As will be appreciated, various techniques exist for providing security to media content. An exemplary data format is discussed in more detail below with respect to FIG. 4. Preferably, the stream includes several copies of the stream key encrypted with a number of service level keys. In one embodiment, the streams are protected using SRTP (secure real-time transport protocol), IMSACrypt, or the like. SRTP defines a profile of RTP (Real-time Transport Protocol), intended to provide encryption, message authentication and integrity, and replay protection to the RTP data in both unicast and multicast applications. SRTP is well known in the art and, thus, will not be described in detail herein.

The procedure of enabling the media content may be transparent to the purchaser. For example, the purchaser may have an account on file with the authorization network 34 such that each time media content is transferred from the distribution network 32 to his electronic equipment 36a, his account is automatically charged the fee associated with the particular media content (with little or no intervention by the purchaser). Similarly, if the purchaser is using a subscription service, each time media content is transferred, the authorization network 34 may be automatically contacted and the media content enabled without intervention from the purchaser.

If the purchaser enjoyed the media content, he may recommend the media content to another potential purchaser (i.e., a second potential purchaser), such as a friend or family member. Further, the purchaser may provide the media content to the second potential purchaser by transferring or streaming the media content from the first electronic equipment 36a to the potential purchaser's (e.g., the friend's) electronic equipment (i.e., a second electronic equipment 36b). In this manner, the second potential purchaser need not access and/or browse for the media content on the distribution network 32, thereby saving the second potential purchaser the time associated with searching and retrieving the media content. Streaming or transferring of the media content from the first electronic equipment 36a to the second electronic equipment 36b may be via a communication medium 40, such as an internet connection (both wired and wireless), a telephone connection (land based, cellular or satellite) or via a local connection (e.g., BlueTooth, cable, or a wired link), or the like. Although the communication medium 40 and the distribution medium 38 are shown as being different mediums, they may be the same medium.

The above example illustrates streaming from a first electronic equipment to a second electronic equipment. As will be appreciated, the media content also can be streamed from a first electronic equipment to multiple electronic equipment, thereby creating a peer-to-multipeer.

As the media content is being transferred or streamed to the second electronic equipment 36b, it is in a disabled state. To view, listen to, or execute the media content, the second potential purchaser must access the authorization network 34 and pay for the right to play the media content as described previously (e.g., obtain a license). As discussed above, payment may be via a pay-per-view service or on a subscription service. Once payment has been made for the media content, the media content is enabled or activated (e.g., the authorization network 34 provides a key or the like to the second electronic equipment 36b that enables or otherwise activates the media content). Enablement of the media content may take place as the media content is being transferred or streamed from the first electronic equipment 36a to the second electronic equipment 36b, or after the media content has been completely transferred or streamed to the second electronic equipment 36b.

Alternatively, the second potential purchaser (the recipient of the media content) may use the first purchaser (the sender of the media content) as a conduit for paying for the media content. In this manner, the recipient need not create an account with the authorization network 34. For example, the purchase of the media content may be via the sender's account (e.g., the sender directly paid for the recipient), or the recipient can provide payment information, such as a credit card number or the like, to the authorization network 34 via the sender's account. In this manner, the recipient pays for the media content without the hassle of creating an account.

As can be seen in FIG. 2, the first electronic equipment 36a can be used to transfer or stream the media content to a plurality of different electronic equipment. For example, the first electronic equipment 36a, via the communication medium 40, can transfer or stream the media content to the second electronic equipment 36b, a third electronic equipment 36c and a fourth electronic equipment 36d. However, prior to playing or executing the media content, the respective recipients must enable the media content as described above. In this manner, a conditional stream access is created, wherein media content may be transferred or streamed, yet only executed after the recipient has paid for right to play the media content. In other words, a conditional stream access system is provided that enables transferring or streaming of media, yet ensures content owners are compensated each time a new individual executes the media content. A benefit of the conditional stream access system is that media content can be transferred or streamed from one electronic equipment to another, without the need to access the distribution network 32, search for the media content on the distribution network 32, and then transfer the media content from the distribution network 32 to the electronic equipment. Moreover, the content owner, via the authorization network 34, can receive credit each time the media content is executed by a new recipient.

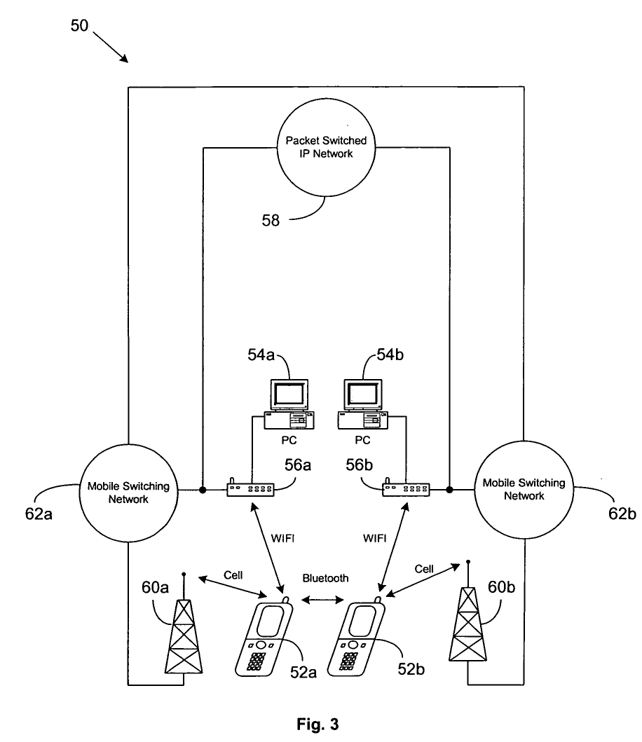

Referring briefly to FIG. 3, there is shown an exemplary diagram 50 illustrating various communication mediums 40 that can be used for electronic equipment embodied as cellular phones. A first and second cellular phone 52a and 52b can transfer or stream data via a number of different conduits. For example, media content can be directly transferred or streamed between the respective phones using a BlueTooth communication link. Alternatively, media content can be transferred or streamed from the first cellular phone 52a to a first PC 54a, a second PC 54b and/or the second cellular phone 52b, and vice-versa, via a WIFI connection using a wireless router 56a and 56b and/or a packet switched IP network 58 (e.g., the internet, a local area network, a wide area network, etc.). Additionally, media content may be transferred or streamed from the first cellular phone 52a to the first PC 54a, the second PC 54b or the second cellular phone 52b, and vice-versa, via a cellular communication link using cellular towers 60a and 60b and mobile switching networks 62a and 62b. As will be appreciated, a number of other connections may be established that are not shown in FIG. 3. For example, a BlueTooth communication link may be established between the cellular phones 52a and 52b and the PCs 54a and 54b.

Each time the media content is transferred or streamed from one electronic equipment to another, the owner of the electronic equipment that originates the stream may be given a credit that can be used for the purchase of future media content. For example, and referring back to FIG. 2, the owner of the first electronic equipment 36a (i.e., the first purchaser) streamed the media content to three different electronic equipment 36b, 36c and 36d. If the media content was enabled on each of the three different electronic equipment, then the first purchaser may be given a credit for each subsequently enabled media content. This is advantageous for both the content owner (his content is being promoted by other users, which can result in additional sales) and the purchaser (each subsequent purchase directly related to his transferring or streaming activities can result in a discount on future media content).

Further, multiple generations of the media content can be created as the media content permeates across the world. For example, in FIG. 2 the first electronic equipment 36a received the media content directly from the distribution network 32. Accordingly, the version of the media content on the first electronic equipment 36a can be referred to as a first generation copy. As the first generation copy is transferred or streamed from the first electronic equipment 36a to the second, third and fourth electronic equipment 36b, 36c and 36d, respectively, each electronic equipment 36b, 36c and 36d receives a second generation of the media content. Additionally, each electronic equipment 36b, 36c and 36d may further transfer or stream the media content to other electronic equipment. For example, the fourth electronic equipment 36d, via the communication medium 40, may transfer or stream the media content to a fifth electronic equipment 36e, thereby creating a third generation of the media content on the fifth electronic equipment 36e.

Additionally, limitations may be imposed on the number of different generations of a particular media content that are allowed to exist. For example, if a particular media content has reached a maximum generation number (e.g., it has been retransmitted by a predetermined number of different electronic equipment), then enablement of the media content may be denied. Such limitations on the number of generations of the media content may be desirable for risk management, for example. Additionally, enablement of the media content may be based on the generation of the media content. For example, different activation keys may be provided to different generations of the same media content. This can reduce the likelihood of successful tampering of the media content by “hackers”.

FIG. 4 illustrates a simplified block diagram of a data format 60 that includes a header 62 and encrypted content 64 that can be used in conjunction with transferring or streaming the media content. A first portion of the header 62 can be any conventional format used for transmitting and/or receiving data. This can include a key ID 62a and a license acquisition URL 62b. A key ID and license acquisition URL 62b are well known in the art and thus will not be discussed in detail herein. Briefly, the key ID 62a is string used to generate a key and uniquely identify the media content file, while the license acquisition URL points to the URL where the license may be acquired.

Although not shown, encryption of the media content also can include the use of a private signing key and a license key seed. A private signing key is a key known by the content creator that is used to sign the content header, while a license key seed is a value used to generate the key. To encrypt the media content, the key ID 62a and the license key seed (not shown) are used to generate or specify a key. Next, the content header 62 is generated and signed using the private signing key (not shown), and then the media content is encrypted using the above information.

As will be appreciated, the above described data rights management technique is merely exemplary and any content protection scheme may be employed without departing from the scope of the invention.

In addition to the above data fields, a generation identifier 62c can be provided that identifies the generation of the received media content, and a sender identifier 62d that uniquely identifies the sender of the media content (e.g., an account number or the like). The generation identifier 62c and sender identifier 62d can be part of the header 62, or separate from the header 62. Each time the media content is transmitted or streamed by an electronic equipment, the generation identifier 62c is incremented and the sender identifier 62d is changed. For example, and briefly referring back to FIG. 2, the first electronic equipment 36a receives the media content with a generation identifier of 0 (i.e., it is the first generation of the media content) and the sender identifier (e.g., an identification string that identifies the sender). As the media content is transferred or streamed from the first electronic equipment 36a to the second, third and fourth electronic equipment 36b, 36c and 36d, the generation identifier 62c is increment by one, and the sender identifier 62d is changed to reflect the new sender. The sender identifier 62d may be an account number, or any other string that can uniquely identify the sender. Thus, second, third and fourth electronic equipment 36b, 36c and 36d each receive the media content with a generation identifier set to one and the sender identifier of the sender. Now, as the fourth electronic equipment 36d transfers or streams the media content to the fifth electronic equipment 36e, the generation identifier again is incremented and the sender identifier is changed, such that the fifth electronic equipment 36e receives the media content with a generation identifier of two and the new sender identification. As noted previously, the generation identifier can be used to limit the number of permeations of a particular media content.

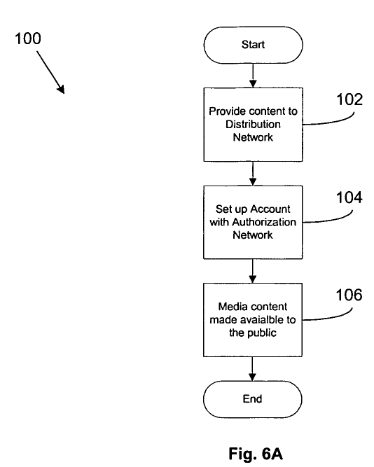

Moving now to FIG. 5, a block diagram of an exemplary mobile phone 70 that can be used in conjunction with the invention is shown. The mobile phone 70 includes an antenna 72 operatively coupled to a radio circuit 74. The radio circuit 74 can include an accessory communications circuit 74a (e.g., BlueTooth or other wireless communications technique) for communicating with an accessory or other electronic equipment, a conventional mobile phone receiver/transmitter 74b for communicating via a conventional mobile phone network (e.g., via cellular towers or satellite), and a wireless network communications circuit 74c (also referred to as WIFI) for communicating with a LAN or WAN, for example. Although not shown, it will be appreciated that separate antennas may be provided for each of the respective radio circuits 74a, 74b and 74c. The mobile phone also includes a sound processing circuit 76, which, in conjunction with a microphone 78 and speaker 80, enable sound to be input and output from the mobile phone 70. Further, an I/O interface 82 distributes power from a power supply 84 (e.g., a battery) to the various sections of the mobile phone 70, and the I/O interface 82 receives data from a key pad 86 and provides data to a display 88. The radio circuit 74, sound processing circuit 76 and I/O interface 82 are operatively coupled to a processor 90 (e.g., a CPU), which, in conjunction with memory 92 and timer 94, executes code stored in memory 92 so as to implement the mobile phone functionality, e.g., wireless voice communications, recognition of keypad entries, display control, WAN interface, data transfer, accessory communications, etc.

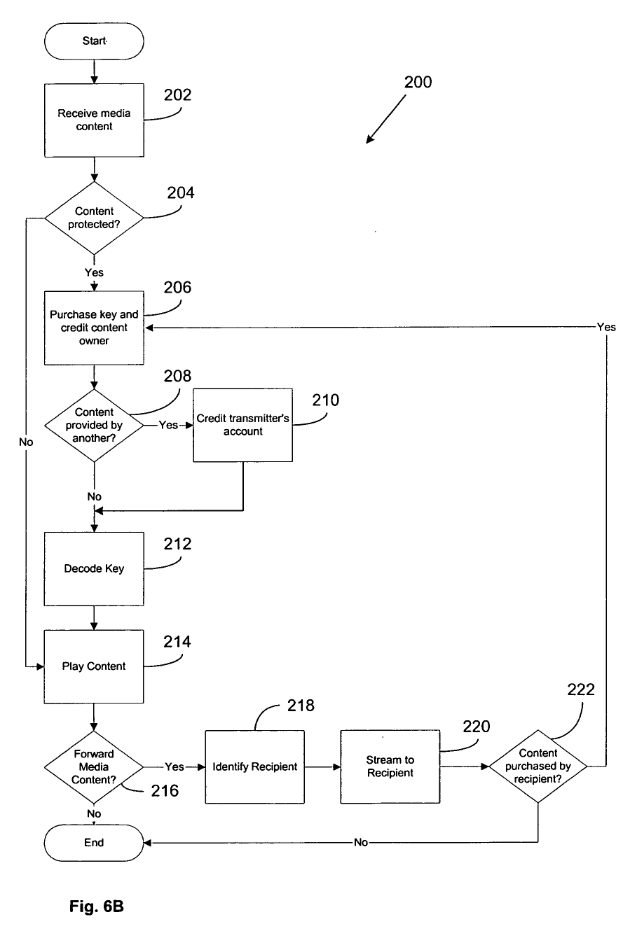

Referring now to FIGS. 6A and 6B, flow diagrams 100 and 200 illustrating an exemplary method for implementing conditional stream access is provided. The flow diagram includes a number of process blocks arranged in a particular order. As should be appreciated, many alternatives and equivalents to the illustrated steps may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

FIG. 6A provides an exemplary method for setting up the media content for distribution and for receiving payment from purchasers. FIG. 6B provides an exemplary method of implementing conditional stream access of the media content.

Beginning with step 102 of FIG. 6A, the content owner, after creation of the media content, provides the media content to the distribution network 32. For example, the content owner can place the media content on the distribution server 32 (e.g., by uploading the content to the server). Additionally, the content owner can enter information about the media content (e.g., what it is or does, why it is useful, etc.). Further, the content owner can check the appropriate boxes to make the media content available or not available (e.g., by making the appropriate entries in a predefined electronic form, as is conventional). Preferably, the distribution server 32 includes a predefined interface that that allows the content owner to easily upload and describe the media content. The interface can be a conventional web page interface, for example.

Next, at step 104, the content owner accesses the authorization server 34 and creates an account for the media content. Creation of the account can include payment information, mailing address, media content identification, fee to be charged for the media content, etc., as is conventional. If the content owner previously has made media content available on the system, the previously entered account information may be reused, and only new information may be entered by the content owner (e.g., the media content identification and the associated fee), thereby saving the content owner time. Once the account has been setup, the media content is ready for transfer and activation by the general public, as indicated at step 106.

Moving now to FIG. 6B, a flow diagram 200 for an exemplary method of implementing the conditional stream access is shown. Beginning at step 202, the media content is received by an electronic equipment (e.g., electronic equipment owned by a potential purchaser). The media content may have been received from the distribution network 32, or via another electronic equipment (e.g., via a transfer or stream from one friend to another). Upon receiving the media content, the electronic equipment determines whether the content is protected, as indicated at step 204. If the content is not protected, then the media content may be played or executed without obtaining a key or otherwise enabling the media content, as indicated at step 214. However, if the media content is protected, then at step 206, the electronic equipment accesses the authorization network 34 and, if an account has not previously been created for the particular purchaser, then the appropriate account information is collected (e.g., billing information, name, etc.) and the account is created. Preferably, the authorization server of the authorization network 34 includes a predefined interface that enables the prospective purchaser to easily and quickly create and/or access his account. Once the account is created, payment is made for the media content (payment can be made using a credit card via a secure connection, for example), and then the media content is enabled (e.g., a key is provided to the electronic equipment that decrypts the media content, and the content can be played or executed). Further, the content owner is credited for the purchase of the media content via a fund transfer or credit to the content owner's account.

At step 208, it is determined if the purchased media content was a result of a transfer or stream from another individual (e.g., a transmission from a friend). If the purchase is not related to the transfer from another individual, then the method moves to step 212. However, if the purchase was the result of a media stream other than a direct transfer from the distribution network 32, then a credit is applied to the individual's account who initiated the transfer or stream of the media content, as indicated a step 210. In this manner, individual's have an incentive to promote the media content. At step 212, the key is decoded and at step 214, the media content is played or executed.

At step 216, the purchaser can forward the content to friend (e.g., if he enjoyed the media content or thought someone else may enjoy the content, he may wish to share it with them). In forwarding the media content, the recipient first is identified at step 218 (e.g., via an email address, IP address, or the like). Once identified, then at step 220 the media content is streamed to the recipient. As discussed above, the media content is in the disabled state on the receiving device. Thus, in order to execute the media content, the recipient first must activate the media content. At step 222, the recipient may choose not to activate the media content, and the method ends. However, if the recipient does choose to activate the media content, then the method moves back to step 206 and steps 206-222 are repeated.

Accordingly, a method for providing conditional stream access has been disclosed. The method enables a revenue stream for content owners when the content is transferred or streamed peer-to-peer. Further, individuals are encouraged to share the media content with others. In doing so, they may earn credits toward the purchase of other media content.

Specific embodiments of an invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of transacting business in conjunction with playing protected media content owned by a media content owner, wherein said protected media content has been provided and enabled for playback on a first electronic equipment, comprising the steps of:
streaming the protected media content from the first electronic equipment to a second electronic equipment, wherein said streamed media content is in a disabled state on the second electronic equipment; and
obtaining from an authorization server a license that enables playback of the protected media content on the second electronic equipment.

2. The method of claim 1, further comprising using a mobile phone as the electronic equipment.

3. The method of claim 1, wherein streaming the protected media content includes at least one of streaming peer-to-peer or streaming peer-to-multipeer.

4. The method of claim 1, further comprising the step of streaming the media content via a first medium and providing the license via a second medium different from the first medium.

5. The method of claim 1, wherein a medium used for streaming the media content and a medium used for providing the key are the same medium.

6. The method of claim 1, wherein playback includes playing the media content on the electronic equipment.

7. The method of claim 1, wherein the license includes a key that enables the media content.

8. The method of claim 7, wherein the key obtained by the second electronic equipment is different from the key obtained by the first electronic equipment.

9. The method of claim 1, further comprising the step of providing credits to an owner of the respective electronic equipment each time the respective electronic equipment streams the media content to a different electronic equipment of the plurality of electronic equipment and the media content is enabled on the different electronic equipment.

10. The method of claim 9, wherein each stream of the media content includes encoding the media content with an identifier prior to transmission, said identifier indicative of a generation of the media content relative to a previous transmission of the media content.

11. The method of claim 10, further comprising the step of denying a license for the media content if the identifier corresponds to a predetermined identifier or range of identifiers.

12. The method of claim 1, wherein the step of obtaining the license includes obtaining the license without user intervention.

13. The method of claim 1, wherein the step of obtaining the license includes obtaining the license based on a subscription service or a pay-per-use service.

14. The method of claim 1, wherein the step of obtaining the license includes obtaining the license as the media is streamed or after the media has been streamed.

15. The method of claim 1, further comprising providing a credit to the media content provider based on the enablement of the protected media content.

16. A computer program product directly loadable into internal memory of a digital computer, comprising software code portions for performing the steps of claim 1 when said product is run on a computer.

17. A program embodied in a computer readable medium for playing protected media content on at least one of a plurality of mobile radio terminals, comprising:
code that streams the protected media content from a first mobile radio terminal of the plurality of mobile radio terminals to a second mobile radio terminal of the plurality of mobile radio terminals, wherein said streamed media content is in a disabled state on the second mobile radio terminal;
code that obtains from an authorization server a license that enables playback of the protected media content on the second mobile radio terminal.

18. A mobile radio terminal comprising a memory, wherein said memory includes the program of claim 17.

19. A system for providing conditional access of media content distributed between a plurality of electronic equipment, comprising:
a distribution server that includes media content stored thereon;
an authentication server for selectively providing a license to enable the media content;
a first electronic equipment of the plurality of electronic equipment, wherein the first electronic equipment includes disabled media content obtained from the distribution server, and said first electronic equipment includes a license from the authentication server, said license enabling the media content; and
a second electronic equipment of the plurality of electronic equipment, wherein the media content is streamed from the first electronic equipment to the second electronic equipment, said media content being in a disabled state on the second electronic equipment, and said second electronic equipment obtaining a license for the media content to enable the media content.

20. The system of claim 19, wherein the second electronic equipment obtains the license directly from the authentication server.

21. The system of claim 19, wherein the second electronic equipment obtains the license from the authentication server through the first electronic equipment.

22. The system of claim 19, wherein a content owner of the media content receives a credit each time a license is obtained for the media content.

23. The system of claim 19, wherein an owner of each electronic equipment of the plurality of electronic equipment receives a credit each time a license is obtained for media content transmitted by the respective electronic equipment.

24. The system of claim 19, wherein the authentication server and the distribution server are the same server.

25. The system of claim 19, wherein the media content is at least one of an audio file, video file, or executable code.

26. The system of claim 19, wherein the electronic equipment is a mobile phone.

27. The system of claim 19, wherein streaming the media content includes at least one of streaming peer-to-peer or streaming peer-to-multipeer.

28. The system of claim 19, wherein media content is executable or playable on the electronic equipment.

29. The system of claim 19, wherein the license includes a key that enables the media content.

30. The system of claim 19, wherein each stream of the media content includes encoding the media content with an identifier prior to transmission, said identifier indicative of a generation of the media content relative to a previous transmission of the media content.

31. The system of claim 30, wherein the authentication server denies a license for the media content if the identifier corresponds to a predetermined identifier or range of identifiers.
